(19) United States
(12) Patent Application Publication
(10) Pub. No.: US 2006/0182594 A1
(43) Pub. Date: Aug. 17, 2006

(54) Transfer apparatus

(76) Inventors: Bernd Wager, Kirchdorf (DE); Werner Seifried, Ulm (DE); Thomas Zitterbart, Dietenheim (DE)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/191,306

(22) Filed: Jul. 28, 2005

(30) Foreign Application Priority Data
Dec. 21, 2004 (DE) 20 2004 019 708.1

(51) Int. Cl. B66C 23/00

(52) U.S. Cl. 414/691

(57) ABSTRACT

The invention relates to a transfer apparatus comprising an operator cabin articulated at a movable and travelable boom. In accordance with the invention, the operator cabin is arranged in a suspended manner at the free end of the boom.

The invention relates to a transfer apparatus in accordance with the preamble of claim 1.

Transfer apparatus are to be understood in this connection as transfer apparatus, for example, for wood, junk or any other goods, but also as excavators and cranes. It is already known with transfer apparatus of this kind to provide an operator cabin as vertically adjustable to permit an improved view over the working area, for example cargo hatches, railroad cars or similar. The operator can carry out more precise and faster working cycles thanks to the higher seating position.

The described cabin elevation positions can be of a rigid construction or be brought into a higher position via arms and actuators.

For instance, a mobile loading machine is known from DE 42 25 948 A1, for example, whose cabin can be raised from a starting position close to the machine base by means of parallel connecting rods supported at its base. In this adjustment apparatus, the connecting rod pair engaging at the cabin base in the starting position extends rearwardly up to an elevated fixed connection at the revolving superstructure and can be raised together with the cabin along an arc of a circle with the help of a driving cylinder.

A cabin adjustment apparatus of a machine is known from DE 26 31 578 C3 in which a parallel connecting rod transmission is provided for the vertical adjustment of a cabin articulated at the cabin base on the one side and articulated at a column arranged behind the cabin on the other side. The rotatable column is arranged very closely behind the front cabin position so that the cabin remains at least partly above the vehicle in its position facing the rear which can be reached by rotating the column about its vertical axis.

In addition to such a vertical adjustment of the cabin remaining above the machine base, there is frequently the need to move the cabin further forward in the direction of the boom.

To achieve this, in accordance with DE 44 43 170 C2, the boom is made of two lifting frames which are coupled to one another and which have a support piece at their front end to accommodate a cab. The lifting frames consist, in accordance with this specification, of two parallel connecting rod transmissions which are arranged pivotably to one another centrally over a metal connection plate. The pivoting takes place by corresponding piston-in-cylinder arrangements at the parallel connecting rod transmissions.

It is also already known from EP 0 960 982 B1 to pivot the operator cabin of a transfer apparatus or of a machine via two parallel connecting rod transmissions which are pivotable with respect to one another and which can be driven via piston-in-cylinder arrangements.

The above teaching specifications have the following disadvantages. On the one hand, the movable booms have a number of support positions and they include a plurality of individual parts which have to be operated. The total structure of the booms is hereby complex and cost-intensive.

On the other hand, the pivot angle of the parallel connecting rod transmissions, and thus the working range of the cabin elevation position, is limited.

It is the object of the present invention to provide a transfer apparatus comprising a correspondingly vertically adjustable operator cabin in accordance with the preamble of claim 1 which should be positionable in as flexible a manner as possible, with the total design being made as simple as possible.

This object is satisfied in accordance with the invention by the totality of the features of claim 1. In accordance with the solution of the invention, the operator cabin is arranged in a suspended manner at the free end of the boom. A very simple design can hereby be realized which is very robust, on the one hand, and permits a flexible movability of the operator cabin, on the other hand.

Preferred aspects of the invention result from the dependent claims following on from the main claim.

Accordingly, the boom can consist of at least two arms connected to one another in an articulated manner and correspondingly associated actuators.

The operator cabin is particularly advantageously suspended above its center of gravity. It is thus ensured that it always moves back into the same starting position on the pivoting of the boom.

In accordance with a special aspect of the invention, a positioning apparatus for the pivoting of the operator cabin can be arranged between the operator cabin or a support construction supporting it and the pivot point at the boom.

This actuator is in particular of advantage when the operator cabin is suspended beneath its center of gravity. The position of the operator cabin can here be tracked by the actuator on the pivoting of the boom.

To increase the flexibility of the operator cabin setting, the boom can have one or more telescopic arms.

The operator cabin can be guided in a compulsory manner via suitable transmissions by means of a shape matched connection parallel to the ground or at a specific angle thereto.

Toothed belts, chain gearing or toothed wheels can be used as the transmission.

The boom can have two parallel connecting rod transmissions pivotably connected to one another as corresponding transmission means.

The arms of the boom are typically straight. However, they can also be curved.

The arms of the boom are particularly advantageously made as closed box sections. A high torsion strength and bending strength are hereby ensured.

The arms can have one or more hollow sections at their interior to be able to accommodate the required cables and hoses to the operator cabin system therein.

The boom can be rotatable with respect to the transfer apparatus via a pedestal arranged rotatably on the transfer apparatus. The arms of the boom can be moved via additional relay arms by means of actuators engaging thereon. Larger pivot angles thereby result as well as the possibility of folding the movable boom in a compact manner.

The operator cabin can be made in a self-supporting manner. However, it can also consist of a support structure and a cabin held therein.

The operator cabin is advantageously suspended in a damped manner, with the damping taking place in dependence on the pivot acceleration and pivot delay.

Further features, details and advantages of the invention result from the following description of the embodiments shown with reference to the Figures. There are shown:

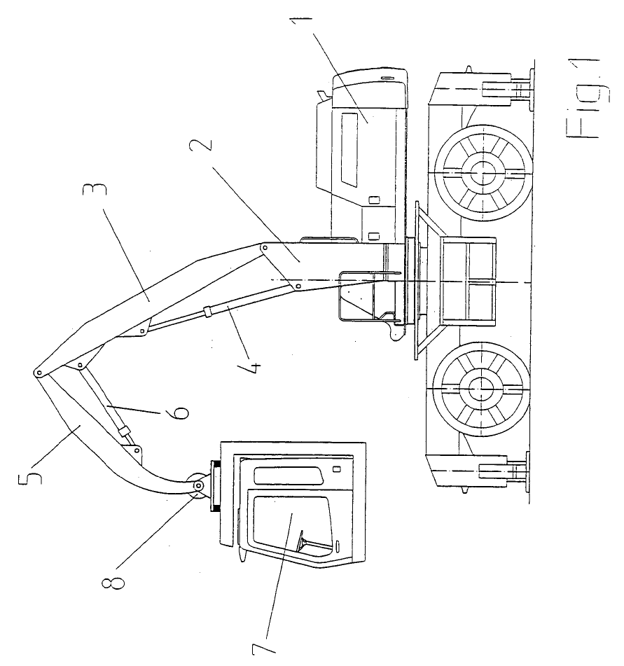

FIG. 1: a first embodiment of a transfer apparatus in accordance with the invention;

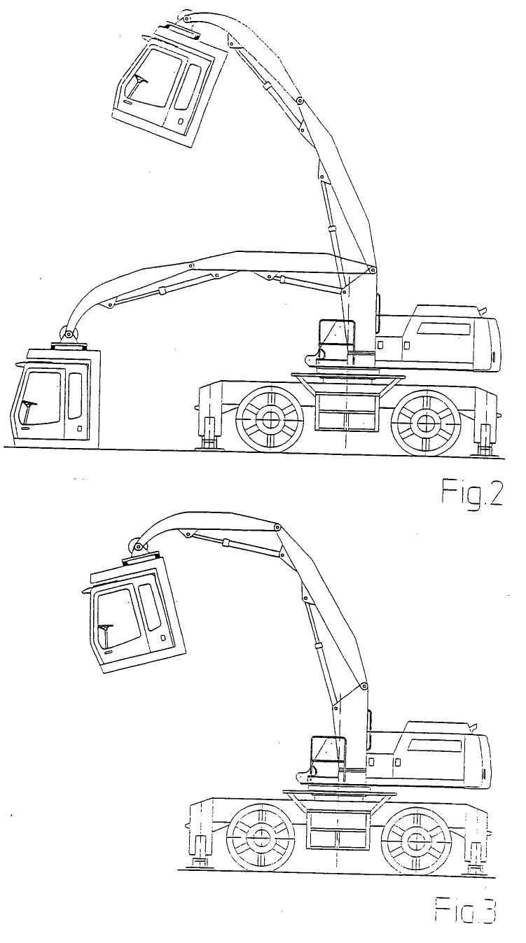

FIGS. 2 and 3: the transfer apparatus of FIG. 1 in different operating positions;

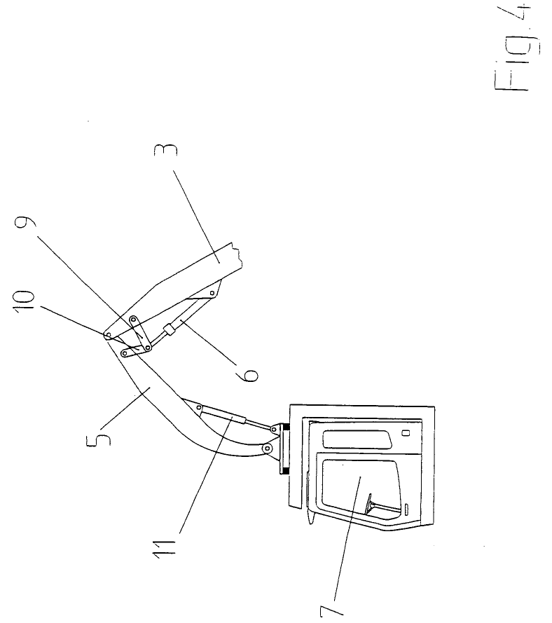

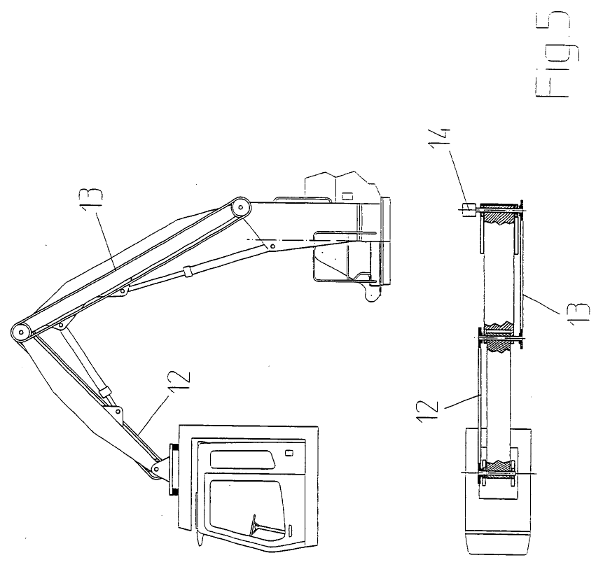

FIG. 4: a part-representation of a transfer apparatus in accordance with the invention in accordance with a further embodiment variant;

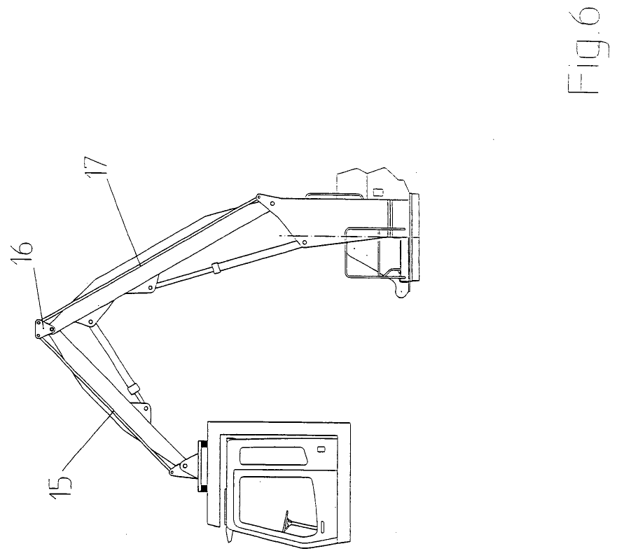

FIG. 5: a third embodiment variant of a transfer apparatus in accordance with the invention in a detailed representation from the side and from above;

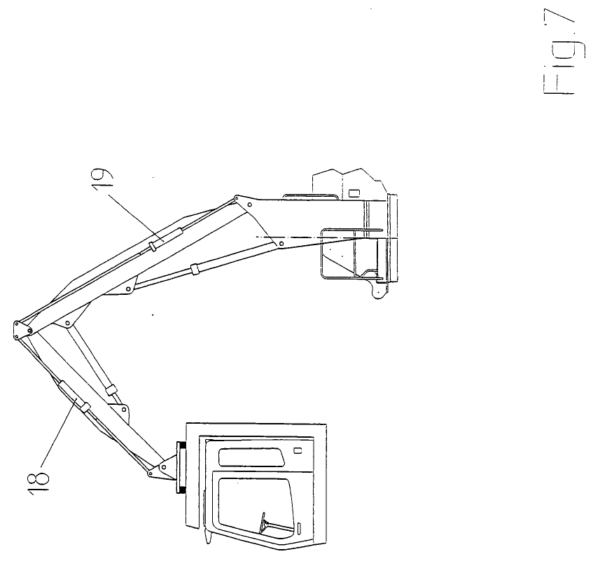

FIG. 6: a fourth variant of the transfer apparatus in accordance with the invention; and

FIG. 7: a fifth alternative embodiment of the transfer apparatus in accordance with the invention.

In FIG. 1, a transfer apparatus is shown having a revolving superstructure 1 on which a support part 2 is attached. The support part 2 is provided with articulation positions for a first arm 3 of a boom and for one or more first actuators 4.

The first arm 3 is likewise provided with articulation positions for the support part 2 and for the first actuator. In addition, additional support positions for a second arm 5 and one or more second actuators 6 are provided at the first arm. The actuators are piston-in-cylinder arrangements 4 and 6 in the embodiment shown here.

The support part 2, the first arm 3 and the first actuator or actuators 4 form a first four-bar linkage, whereas the first arm 3, the second arm 5 and the second actuator or actuators 6 form a second four-bar linkage.

An operator cabin system 7 is arranged in a suspended manner at the end of the second arm 5. The operator cabin system 7 can be brought into any position within the adjustment range predetermined by the kinematics and can be held there by the adjustment of the actuators 4 and 6.

The operator can thus, for example, enter the operator cabin system 7 level with the ground and be brought into an optimum viewing position for the work to be carried out, as is shown with reference to FIG. 2 with respect to the two positions of the operator cabin system 7 shown there. In a corresponding design of the revolving superstructure, the operator cabin system can also be positioned at the level of the revolving superstructure so that the operator moves directly onto the revolving superstructure through a door arranged in the rear region of the cabin, for example, and can there, for example, carry out adjustment work on the engine.

The operator cabin system 7 is suspended above its center of gravity, for example in the roof region, so that a stable balance state is always adopted due to gravity. If the cabin system is articulated beneath the center of gravity (not shown here), an actuator 8 provides the automatic cabin tracking, with an inclination control being carried out here.

It is furthermore possible to bring the cabin out of its usually horizontal position by means of the positioning device 8 into a position inclined to the front or to the rear. Even better and more ergonomic viewing conditions thereby result for the operator since the operator's neck, for example, does not have to be overstretched for the view far up (filling a silo). Corresponding positions of the cabin are shown in FIGS. 2 and 3 of the first embodiment of the invention.

The operator cabin system 7 can have a Cardanic attachment or an attachment damping around all 6 axles to minimize the strains for the operator. The operator cabin can advantageously also be rotated about its normal axis. The operator cabin can furthermore be displaced to the front and to the rear in the direction of the longitudinal axis of the vehicle by means of a suitable guide element if this is provided (not shown here).

The positioning device 8 is in a position to ensure the inclination position of the cabin system 7. If the cabin system is moved into a specific position, the positioning device 8 permits the free or damped movement of the operator cabin system 7. If the positioning movement has ended, the positioning device 8 provides a secure and firm holding of the cabin system 7 in the desired position and inclination. The positioning device can, for example, also be a hydraulic cylinder 11 such as is shown with reference to the embodiment in accordance with FIG. 4 in addition to a hydraulic engine with transmission. Electrically or pneumatically driven actuators (not shown here) are likewise feasible. In the embodiment in accordance with Figure 4, the arms 3 and 5 of the boom are also equipped with additional relay arms 9 and 10 which are movable via the actuators 4 and 6. Larger pivot angles and the possibility of folding the cabin lift in a compact manner thereby result.

Systems are shown with reference to the embodiment variants in FIGS. 5 and 6 by means of which a parallel guidance of the operator cabin system 7 is ensured.

It is, for instance, already shown in FIG. 5 that a corresponding parallel guidance can be provided via a transmission in the form of a chain drive or a belt drive 12 or 13 which respectively consists of at least two chain wheels or belt wheels as well as of a chain or of a belt. The chain wheel or belt wheel facing the cabin is fixedly connected to the operator cabin system 7. A shaft having two chain wheels or belt wheels connected to the shaft is supported in the joint between the arm 3 and the arm 5. A shape-matched connection for the chain drive or belt drive 12 thereby results. The second chain wheel or belt wheel on the shaft between the arm 3 and the arm 5 forms the second chain drive or belt drive 13 with at least one further wheel. The shaft between the parts 2 and 3 is initially held tight. When the piston-in-cylinder units 4 and 6 are moved, the cabin always remains horizontal in this manner, provided the transmission ratios of the toothed drive or belt drive are equal to one. A position of the operator cabin system 7 deviating from the horizontal can thus automatically also be realized via a variation of the transmission ratios in the toothed drives and belt drives. The possibility further exists of controlling the operator cabin system out of the horizontal position via a setting drive 14 (cf. FIG. 5).

In the embodiment variant in accordance with FIG. 6, another possibility for a parallel cabin guidance is shown. The operator cabin system 7 and the support part 2 are each equipped with an additional pivot point. The struts 15 and 17 shown here as well as the relay arms 16 arranged between them form two parallelograms with the additional support positions. The boom is therefore provided with two parallel connecting rod transmissions here. In this solution shown here in FIG. 6, the operator cabin system 7 is supported in or close to its center of gravity. The cabin load is supported solely by the arms 3 and 5 and by the actuators 4 and 6. The parallel connecting rod transmissions take over substantially lower strain since only a holding function has to be ensured.

Finally, FIG. 7 shows a further embodiment of the invention in which the struts 18 and 19 are adjustable in their length. This can take place fixedly or variably via suitable actuators. The cabin can thus be moved into a position outside the horizontal in contrast to the aspect of FIG. 6.

1. A transfer apparatus comprising an operator cabin articulated at a movable and travelable boom,
characterized in that
the operator cabin is arranged in a suspended manner at the free end of the boom.

2. A transfer apparatus in accordance with claim 1, wherein the boom consists of at least two arms connected to one another in an articulated manner and correspondingly associated actuators.

3. A transfer apparatus in accordance with claim 1, wherein the operator cabin is suspended above its center of gravity.

4. A transfer apparatus in accordance with claim 1, wherein an adjustment apparatus is arranged between the operator cabin or a support construction supporting it and the pivot point at the boom for the pivoting of the operator cabin.

5. A transfer apparatus in accordance with claim 1, wherein the actuator tracks the position of the operator cabin on the pivoting of the boom in the case of the suspension of the operator cabin beneath its center of gravity.

6. A transfer apparatus in accordance with claim 1, wherein the boom can have one or more telescopic arms.

7. A transfer apparatus in accordance with claim 1, wherein the operator cabin is guided in a compulsory manner parallel to the ground or at a specific angle to the ground via suitable transmissions by means of a shape-matched connection.

8. A transfer apparatus in accordance with claim 1, wherein toothed belts, chain drives or toothed wheels are used as the transmission.

9. A transfer apparatus in accordance with claim 1, wherein the boom has two parallel connecting rod transmissions pivotably connected to one another.

10. A transfer apparatus in accordance with claim 1, wherein the arms of the boom are curved.

11. A transfer apparatus in accordance with claim 1, wherein the arms of the boom are made as closed box sections.

12. A transfer apparatus in accordance with claim 1, wherein the arms have at least one hollow section as their interior for the accommodation of the cables or hoses running to the operator cabin.

13. A transfer apparatus in accordance with claim 1, wherein the boom is rotatable with respect to the transfer apparatus via a pedestal arranged rotatably on the transfer apparatus.

14. A transfer apparatus in accordance with claim 1, wherein additional relays arms at which the actuators engage are arranged at the arms of the boom.

15. A transfer apparatus in accordance with claim 1, wherein the operator cabin is made in a self-supporting manner.

16. A transfer apparatus in accordance with claim 1, wherein the operator cabin consists of a support structure and of a cabin held therein.

17. A transfer apparatus in accordance with claim 1, wherein the operator cabin is suspended in a damped manner, with the damping taking place in dependence on the pivot acceleration and pivot delay.

18. A transfer apparatus in accordance with claim 1, wherein the operator cabin is movable out of the horizontal position into a desired tilted position via an adjustment drive.
